(19) United States
(12) Patent Application Publication
(10) Pub. No.: US 2024/0106678 A1
(43) Pub. Date: Mar. 28, 2024

(54) CONSTRAINING COMMUNICATION BETWEEN DEVICES

(71) Applicant: Battelle Energy Alliance, LLC, Idaho Falls, ID (US)

(72) Inventors: Stephen A. Bukowski, Idaho Falls, ID (US); Jake P. Gentle, Idaho Falls, ID (US)

(21) Appl. No.: 18/251,695

(22) PCT Filed: Nov. 16, 2021
(86) PCT No.: PCT/US2021/072435

§ 371 Date: May 3, 2023

Related U.S. Application Data
(60) Provisional application No. 63/118,104, filed on Nov. 25, 2020.

(51) Int. Cl. H04L 12/413

(52) U.S. Cl. CPC H04L 12/413

(57) ABSTRACT

One or more embodiments of the present disclosure may include a device including a first port configured to be communicatively coupled to a first device, a second port configured to be communicatively coupled to a second device, and logic. The logic may be configured, in a permissive operational state, to receive a signal from the first device and transmit the signal to the second device. The logic may further be configured, in a constrained operational state, to transmit a hold signal to the first device, wherein the hold signal instructs the first device to not transmit signals. Associated methods are also disclosed.

### CROSS-REFERENCE TO RELATED APPLICATIONS

This application is a national phase entry under 35 U.S.C. § 371 of International Patent Application PCT/US2021/072435, filed Nov. 16, 2021, designating the United States of America and published as International Patent Publication WO 2022/115832 A1 on Jun. 2, 2022, which claims the benefit under Article 8 of the Patent Cooperation Treaty to U.S. Provisional patent application Ser. No. 63/118,104, filed Nov. 25, 2020, for “Constraining Communication Between Devices.”

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

Embodiments of the present disclosure relate generally to constraining communication between devices, e.g., for security. In some embodiments, communication between two devices may be constrained by a third device that is coupled between the two devices.

### BACKGROUND

Embedded systems (including, e.g., one or more processors, one or more memories, and one or more communications interfaces) may reside upon a device that monitors and controls a particular system. For example a protective relay may perform important functions in a power distribution system including, e.g., detecting and/or reacting to detection of abnormal operating conditions such as over-current, over-voltage, reverse power flow, over-frequency, and under-frequency. A protective relay may include a number of interfaces, wherein each of the interfaces may be related to a function of the protective relay. The interfaces may include serial ports and/or Ethernet ports.

Serial ports, which provide for serial data communication, may include one or more lines, e.g., a transmit line (Tx), a receive line (Rx), and one or more flow control lines. An Ethernet port may provide for communication according to an Ethernet protocol. Communication via the Ethernet protocol may include Ethernet sessions.

### BRIEF SUMMARY

One or more embodiments of the present disclosure may include a method including, in a permissive operational state: receiving, at a device between a transmitter and a receiver, a signal from the transmitter and transmitting the signal to the receiver. The method may also include, in a constrained operational state, transmitting a hold signal to the transmitter, wherein the hold signal instructs the transmitter to not transmit signals.

One or more embodiments of the present disclosure may include a method including receiving a signal from a transmitter and transmitting the signal to a receiver. The method may also include entering a constrained operational state and while in the constrained operational state, transmitting a hold signal to the transmitter, wherein the hold signal instructs the transmitter to not transmit signals.

One or more embodiments of the present disclosure may include a device including a first port configured to be communicatively coupled to a first device, a second port configured to be communicatively coupled to a second device, and logic. The logic may be configured to, in a permissive operational state, receive a signal from the first device and transmit the signal to the second device. The logic may further be configured to, in a constrained operational state, transmit a hold signal to the first device, wherein the hold signal instructs the first device to not transmit signals.

### BRIEF DESCRIPTION OF THE DRAWINGS

While the specification concludes with claims particularly pointing out and distinctly claiming what are regarded as embodiments of the present disclosure, various features and advantages of embodiments of the disclosure may be more readily ascertained from the following description of example embodiments of the disclosure when read in conjunction with the accompanying drawings, in which:

FIG. 1 illustrates an example of an environment in which a system or device according to one or more embodiments of the present disclosure may be configured to operate;

FIG. 2 illustrates an example system according to one or more embodiments of the present disclosure;

FIG. 3A and FIG. 3B illustrate an example system according to one or more embodiments of the present disclosure;

FIG. 4A and FIG. 4B illustrate another example system according to one or more embodiments of the present disclosure;

FIG. 5 illustrates yet another example system, according to one or more embodiments of the present disclosure;

FIG. 6 is a flowchart of an example method, according to one or more embodiments;

FIG. 7 is a flowchart of another example method, according to one or more embodiments;

FIG. 8 is a flowchart of yet another example method, according to one or more embodiments; and

FIG. 9 illustrates a block diagram of an example device that may be used to implement various functions, operations, acts, processes, and/or methods, in accordance with one or more embodiments.

### DETAILED DESCRIPTION

In the following description, reference is made to the accompanying drawings in which are shown, by way of illustration, specific embodiments in which the disclosure may be practiced. The embodiments are intended to describe aspects of the disclosure in sufficient detail to enable those skilled in the art to make, use, and otherwise practice the invention. Furthermore, specific implementations shown and described are only examples and should not be construed as the only way to implement the present disclosure unless specified otherwise herein. It will be readily apparent to one of ordinary skill in the art that the various embodiments of the present disclosure may be practiced by numerous other solutions. Other embodiments may be utilized and changes may be made to the disclosed embodiments without departing from the scope of the disclosure. The following detailed description is not to be taken in a limiting sense, and the scope of the present invention is defined only by the appended claims.

In the following description, elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths, and the present disclosure may be implemented on any number of data signals including a single data signal.

The various illustrative logical blocks, modules, and circuits described in connection with the embodiments disclosed herein may be implemented or performed with “logic” including, e.g., a general purpose processor, a special purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, state machine or remote device. A general-purpose processor may be considered a special-purpose processor while the general-purpose processor executes instructions (e.g., software code) stored on a computer-readable medium. A processor may also be implemented as a combination of computing devices, e.g., a combination of a DSP and a microprocessor, a plurality of microprocessors, one or more microprocessors in conjunction with a DSP core, or any other such configuration.

Also, it is noted that embodiments may be described in terms of a process that may be depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a function, a procedure, a subroutine, a subprogram, etc. Furthermore, the methods disclosed herein may be implemented in hardware, software, or both. If implemented in software, the functions may be stored or transmitted as one or more instructions or code on computer-readable media. Computer-readable media include both computer storage media and communication media, including any medium that facilitates transfer of a computer program from one place to another.

It should be understood that any reference to an element herein using a designation such as “first,” “second,” and so forth, does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

In some situations it may be desirable to constrain communication between two or more devices. For example, for security purposes, it may be desirable to prevent communication regarding certain functions of one or more of the devices at certain times. In the present disclosure, the term “constrain” refers to limiting or preventing communication between two or more devices. The term “constrain” may include preventing all communication or a subset of all communication between the two or more devices. For example, the term “constrain” may refer to preventing communication regarding a specific function of one or more of the devices. As a specific, non-limiting example, a device may be constrained from receiving configuration changes. In the present disclosure, the term “selectively” may refer to constraining communication at certain times or under certain conditions and allowing (or not constraining) communication at other times or under other conditions. Thus, embodiments of the present disclosure may be configured to selectively constrain communication between two or more devices.

One specific, non-limiting example of an environment in which constraining communication may be beneficial is in a power distribution system. For example, constraining communication to and from a protective relay of a power distribution system may provide benefits. For example, the ability to constrain communication to and from a protective relay may increase security of the power distribution system during known or imminent remote attacks. For example, constraining communication to a protective relay may prevent spoofing attacks directed to the protective relay.

In the present disclosure, the term “transmitter” refers to a device that transmits a signal. In the present disclosure, the term “receiver” refers to a device that is an intended destination of a signal. A single device may be both a transmitter and a receiver, i.e., the single device may transmit a first signal and receive a second signal. The single device may be alternatively a transmitter and a receiver or the single device may be both a receiver and transmitter simultaneously (e.g., receiving a first signal while sending a second signal). Referring to a device as a “transmitter” and another device as “receiver” indicates that with reference to a signal, the transmitter transmitted the signal and the receiver is the intended destination of the signal. Thus, either or both of a transmitter and a receiver may receive a signal instructing the transmitter and/or the receiver not to transmit messages (e.g., additional messages).

Systems and/or devices of the present disclosure may be configured to be communicatively connected between two devices (e.g., two communicating devices) such that communication between the two devices passes through (or is constrained by) the systems or devices of the present disclosure. The two devices may be alternatively or simultaneously transmitting signals to and receiving signals from one another i.e., the two devices may be a transmitter and a receiver. Any of the two devices and/or the systems or devices of the present disclosure may be collocated or remote from each other. Communicative connection between the two devices and/or the systems or devices of the present disclosure may be through wired or wireless connections. Further, communicative connections may include any number of intermediary devices.

Systems or devices of the present disclosure may be configured to selectively constrain communication between the two devices. For example, in a permissive operational state, systems or devices of the present disclosure may be configured to allow communication between the two devices, e.g., by relaying signals between the two devices. And, in a constrained operational state, systems or devices of the present disclosure may be configured to prevent some or all communication between the two devices. In particular, systems or devices of the present disclosure, while in the constrained operational state, may be configured to prevent certain communication while allowing other communication. The certain communication may be related to functions that may be restricted to increase security of one or more of the two devices (e.g., configuration communication, software-update communication, and/or firmware-update communication).

Systems or devices of the present disclosure may be configured to constrain communication using operations affecting any of one or more layers of the Open System Interconnection (OSI) networking model. For example, communications may be constrained at a physical layer, a data-link layer, a network layer, or any other layer. In the present disclosure, examples are given with regard to constraining communications through operations at the data-link layer and operations at a session layer. These examples are not limiting.

In the present disclosure, examples are given in which the systems and/or devices of the present disclosure are communicatively connected between two devices. This is not intended to be limiting. Rather, systems and/or devices of the present disclosure may be included between any number of devices. As a specific, non-limiting example, two or more protective relays may be located at a single location. Further, it may be possible to communicate with the two or more protective relays through a single communication unit or channel (e.g., a modem). A system and/or device of the present disclosure may be positioned between the single communication unit or channel and the two or more protective relays. The system and/or device of the present disclosure may be configured to selectively constrain communication between the single communication unit or channel and each or all of the two or more protective relays. As another specific, non-limiting example, two or more controllers may be configured to send instructions to and/or receive data from a single protective relay. A system and/or device of the present disclosure may be communicatively connected between the two or more controllers and the single protective relay.

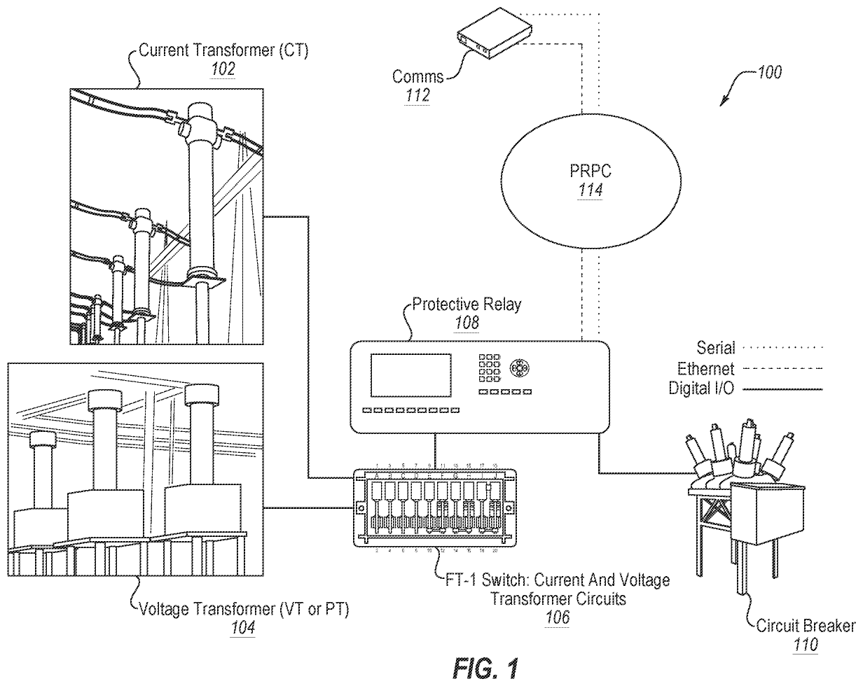

FIG. 1 illustrates an example of an environment 100 in which a system or device according to one or more embodiments of the present disclosure may be configured to operate. For example, a protective-relay permissive-communication device (“PRPC 114”) may be configured to operate in environment 100 according to one or more embodiments of the present disclosure.

Environment 100, which may, for example, be part of a power distribution system, may include a protective relay 108 (that has multiple communication interfaces), one or more current transformers 102, and/or one or more voltage transformers 104. Current transformers 102 and/or voltage transformers 104 may be configured to provide power at a current, voltage, and/or frequency. Operation of current transformers 102 and/or voltage transformers 104 may be governed by transformer circuits 106, which may be controlled by protective relay 108.

Non-limiting examples of communicative connections between the various elements of environment 100 are illustrated by the lines connecting the various elements. In particular, dashed lines represent communicative connections that may include an Ethernet communicative connection, dotted lines represent communicative connections that may include a serial communicative connection, and solid lines represent communicative connections that may include a digital communicative connection.

Protective relay 108 may be configured to detect and/or react to detection of abnormal operating conditions such as over-current, over-voltage, reverse power flow, over-frequency, and under-frequency. Protective relay 108 may be configured to react by controlling one or more circuit breakers 110 and/or transformer circuits 106. Protective relay 108 may be configured to perform operations including, for example, “sense and act,” “alarm and monitor,” “file transfer,” and “phasor measurement” (PMU), via multiple or single communication interfaces. Additionally, protective relay 108 may be configured to receive “management” instructions including for example, setting or querying configurations, software updates or patches, and/or firmware updates or patches via multiple or single communication interfaces.

Protective relay 108 may receive instructions from and/or provide data to another element (e.g., a controller (not illustrated)) (e.g., of the power distribution system) through a communication unit and/or communication channel (“comms 112”). Comms 112 may include any suitable communication units and/or channels, including, for example, serial or peer to peer communications protocols over many different physical and data link layers, without limitation. Comms 112 may include one or more devices connected to a protective relay including, as non-limiting examples: a remote terminal unit, an Ethernet port on a switch, a hub, a router, and/or a modem connected to any type of Time Division Multiplexing Network (TDM). Comms 112 may include one or more interfaces and/or may communicate according to one or more communication protocols. For example, comms 112 may be configured to communicate with protective relay 108 through one or more serial data links and/or one or more Ethernet links. As a specific, non-limiting example, comms 112 may be configured to communicate with protective relay 108 through two or more serial data links, wherein each of the two or more serial data links may relate to a different function of protective relay 108. For example, a first serial data link may provide for communication to and from protective relay 108 regarding “sense and act” functions of protective relay 108 and a second serial data link may provide for communication to and from protective relay 108 regarding “alarm and monitor” functions of protective relay 108. As another specific, non-limiting example, comms 112 may be configured to communicate with protective relay 108 through two or more Ethernet sessions through a single Ethernet link. For example, a first Ethernet session may provide for communication to and from protective relay 108 regarding “sense and act” functions of protective relay 108 and a second Ethernet session may provide for communication to and from protective relay 108 regarding “alarm and monitor” functions of protective relay 108. As another specific non-limiting example, comms 112 may be configured to communicate with protective relay 108 through one or more serial data links and one or more Ethernet links (e.g., including one or more Ethernet sessions). For example, a first serial data link may provide for communication to and from protective relay 108 regarding “sense and act” functions of protective relay 108 and a first Ethernet session may provide for communications to and from protective relay 108 regarding “alarm and monitor” functions of protective relay 108.

PRPC 114, which may be communicatively connected between comms 112 and protective relay 108, may be configured to selectively constrain communication between comms 112 and protective relay 108. As a specific, non-limiting example of selectively constraining communication, PRPC 114 may be configured to prevent all communication regarding management functions of protective relay 108 during certain times or under certain conditions. For example, PRPC 114 may start in a permissive mode of operation. A controller may instruct PRPC 114 to enter a constrained mode of operation for a duration of time. In particular, in the constrained mode of operation PRPC 114 may be instructed to not allow any communication regarding “management” functions to be transmitted to protective relay 108 for the duration of time. Following the duration of time, PRPC 114 may return to the permissive mode of operation. As another example, an operator (e.g., interfacing directly with PRPC 114) may instruct PRPC 114 to not allow any communication regarding “management” functions to be transmitted to protective relay 108 until the operator indicates otherwise. PRPC 114 may be configured to constrain some or all of the communications based upon user preference on a link (e.g., a serial link or an Ethernet link) based upon associated function within the device, which may increase security of environment 100 by reducing the channels by which environment 100 (including protective relay 108) can be attacked.

In some embodiments, protective relay 108 may include an instance of PRPC 114 (not illustrated in FIG. 1). Additionally or alternatively, protective relay 108 may be configured to perform one or more operations described herein with regard to PRPC 114. For example, protective relay 108 may be configured to constrain communications received by protective relay 108, e.g., by dropping communications received during certain times and/or certain types of communications, e.g., when protective relay 108 is in a constrained operational mode.

As noted above, environment 100 of FIG. 1 is a non-limiting example of an environment in which systems or devices of the present disclosure may be configured to operate. Systems or devices of the present disclosure may be configured to operate in other environments. Non-limiting examples of other environments in which systems or devices of the present disclosure may be configured to operate include: any technology network with embedded systems and/or remotes devices that have communication interfaces such as but not limited to operational technology and information technology networks, Supervisory Control and Data Acquisition (SCADA) networks, oil and gas systems, automated manufacturing, batch processing, power system, natural gas networks, without limitation.

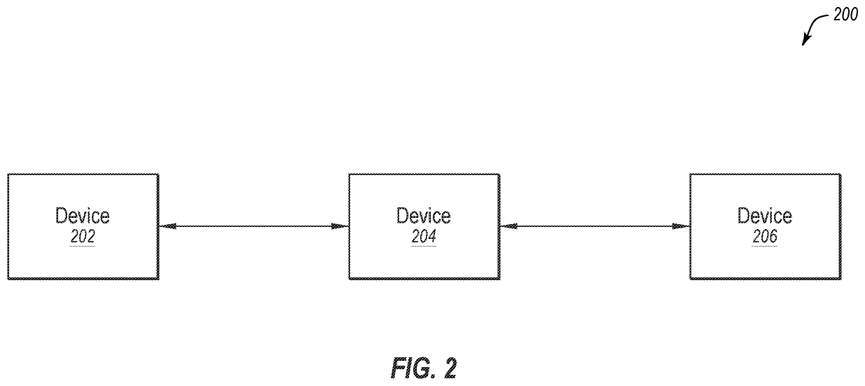

FIG. 2 illustrates a system 200 according to one or more embodiments of the present disclosure. System 200 includes a device 202, a device 204 and a device 206, wherein device 204 is communicatively connected between device 202 and device 206. The communicative connections between device 202, device 204 and device 206 may include wired and/or wireless connections and may include one or more intermediate devices. For example, although not illustrated in FIG. 2, there may be one or more switches, routers, and/or other devices between any of device 202, device 204 and/or device 206. Device 202, device 204, and/or device 206 may or may not be collocated.

Device 204 may be configured to selectively constrain communication between device 202 and device 206. With regard to some signals, device 202 may be a transmitter and device 206 may be a receiver. With regard to other signals, device 206 may be a transmitter and device 202 may be a receiver.

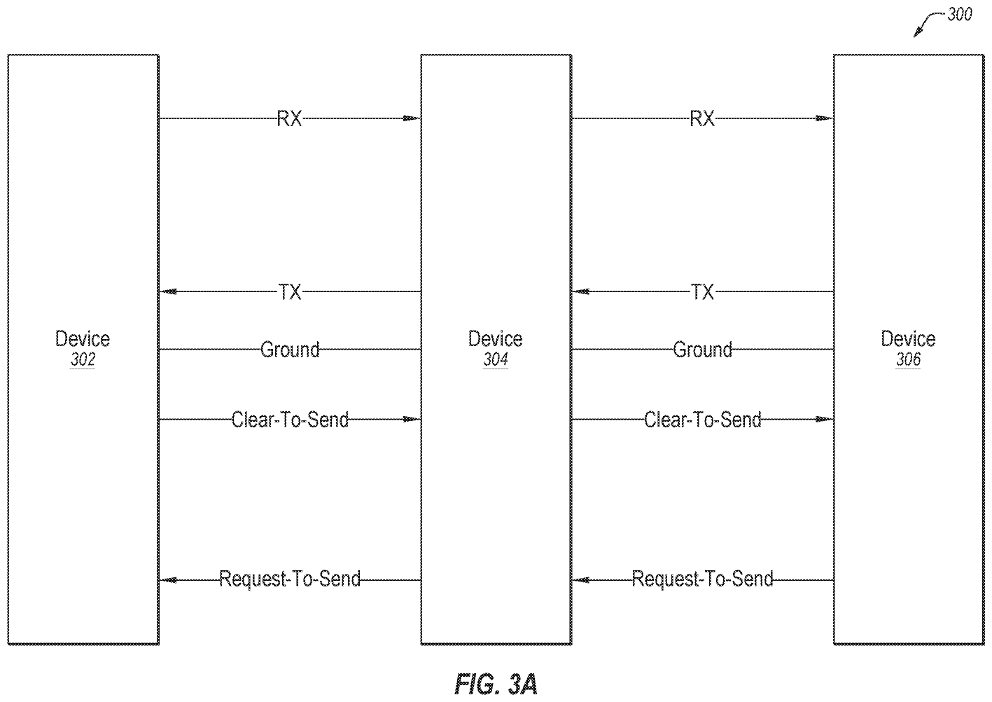

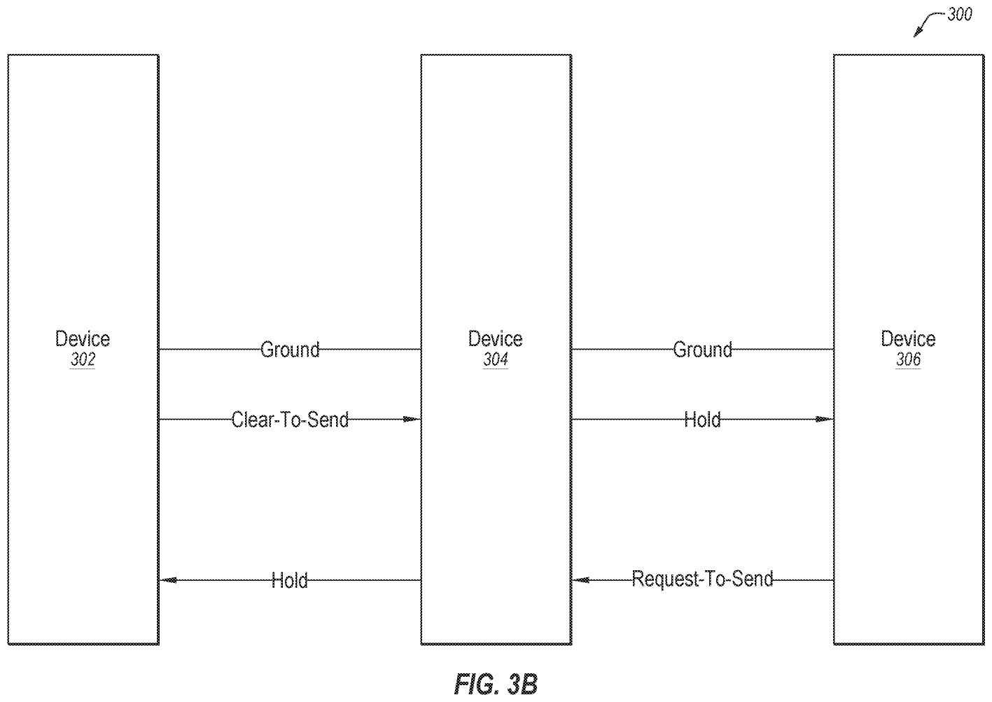

FIG. 3A and FIG. 3B illustrate an example system 300 including a device 302, a device 304, and a device 306, according to one or more embodiments of the present disclosure. System 300 may be an example of system 200 of FIG. 2. In particular, system 300 may be an example of system 200 which includes one or more serial data links between device 302 and device 306. More specifically still, FIGS. 3A and 3B, illustrates an example of a 5 pin RS232 serial implementation.

Device 304 may be communicatively connected between device 302 and device 306 and may be configured to selectively constrain communication between device 302 and device 306. Device 304 may be communicatively connected between multiple serial communication links and may be configured to selectively constrain one or more of the serial communication links. FIG. 3A illustrates a single serial data link, e.g., a serial data link for communicating “management” signals.

Device 306 may be an example of a data terminal equipment (DTE) communicatively connected, e.g., through a serial communication link to device 302, which may be an example of a data circuit-terminating equipment (DCE). Device 306 may be referred to as a transmitter and device 302 may be referred to as a receiver (i.e., with regard to messages sent from device 306 intended for device 302).

The communicative connection between device 302 and device 306 (and between device 302 and device 304 and device 304 and device 306) may be a serial communication link according to any suitable standard, e.g., Recommended Standard (RS) 232C, RS-232D, RS-485, RS-485, RS-422, and inter-integrated circuit (I2C), without limitation. Additionally or alternatively, the serial communication link may use one or more proprietary or non-standard-based serial communication protocols. Any of device 302, device 304, and device 306 may include one or more serial ports according to any suitable standard, e.g., USB, DB9 and DB25 without limitation. Additionally or alternatively, the ports may be according to a proprietary or non-standard configuration.

FIG. 3A illustrates a number of signals between device 302 and device 306. In particular, FIG. 3A illustrates a transmission signal (Tx), a reception signal (Rx), a clear-to-send signal, and a request-to-send signal. According to one or more serial communication protocols, the clear-to-send and the request-to-send signals may be used to implement flow control.

Flow control was primarily designed into early serial communications due to the lack of resources (memory, process, etc.) of a remote embedded device or computer. Flow control can happen between device types over several mechanism including: clear-to-send/request-to-send (CT S/RTS), data-set-ready/data-terminal-ready (DSR/DTR), and transmitting BREAK. BREAK allows a DTE device to pause communications directly via TX. The BREAK signal supports a rarely used form of signaling. Setting the break signal in a Universal Asynchronous Receiver/Transmitter (UART) causes TX to remain at a positive RS-232 voltage, which is opposite of the idle-state voltage. The BREAK signal enables in-line signaling to a microcontroller or other device that has no input buffers of flow-control lines. The BREAK signal also provides a way to toggle the TX line as desired for any purpose.

Device 304 may be configured to use one or both of the clear-to-send signal and the request-to-send signal to constrain communication between device 302 and device 306. For example, device 304 may be configured to set one or both of the clear-to-send signal and the request-to-send signal to control the communication between device 302 and device 306.

For example, in a permissive operational state (e.g., as illustrated in FIG. 3A), device 304 may be configured to allow one or both of the clear-to-send signal and the request-to-send signal to remain as set by one of device 302 and/or device 306. For example, device 302 may set the request-to-send signal to a voltage (e.g., high) to indicate that device 302 is ready to receive a signal (e.g., TX) from device 306. Also, device 306 may set the clear-to-send signal to a voltage (e.g., high) to indicate that device 306 is ready to receive a signal (e.g., RX) from device 302. In the permissive operational state, device 304 may retain the voltages set by the device 302 and device 306 in the clear-to-send and request-to-send signals.

And, in a constrained operational state, (e.g., as illustrated in FIG. 3B), device 304 may be configured to transmit a hold signal to one or both of device 302 and device 306 to instruct one or both of device 302 and device 306 to not transmit a signal. For example, device 304 may be configured to set one or both of the clear-to-send signal and the request-to-send signal to instruct one or both of device 302 and device 306 to not transmit a signal. For example, in the constrained operational state, device 304 may change the voltages of the clear-to-send signal and the request-to-send signal (e.g., from high to low) to indicate that device 302 and device 306 are not ready to receive and/or to instruct device 302 and device 306 to not transmit a signal (e.g., Tx or Rx).

Although communication here is described as between a DCE and DTE, other configurations are contemplated, e.g., communication between a DCE and a DCE or between a DTE and a DTE, e.g., using a crossover cable.

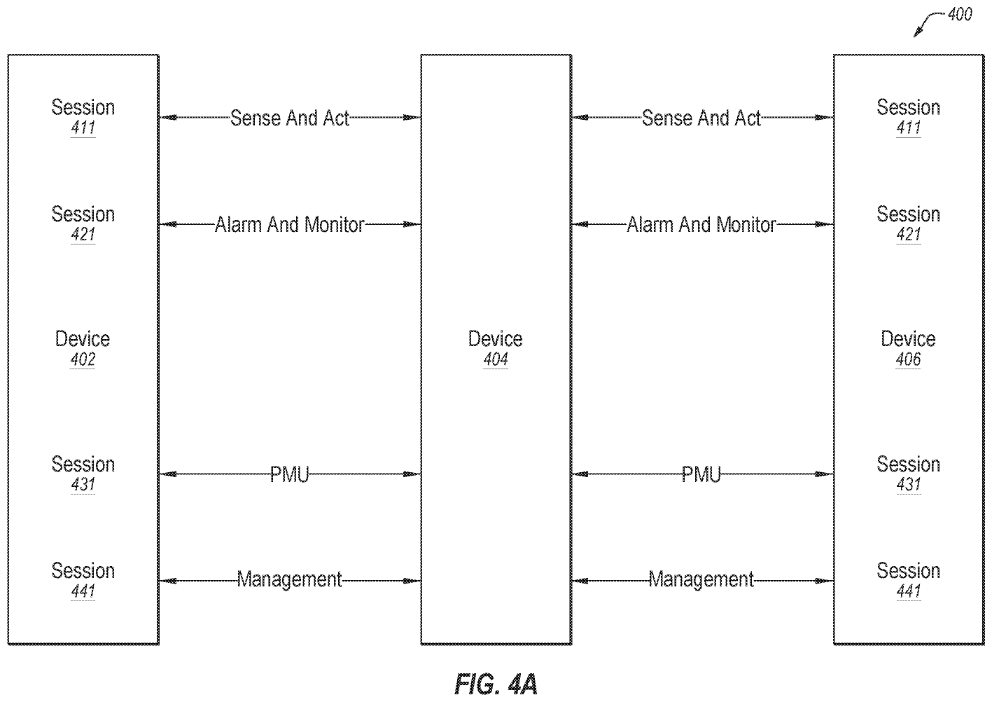

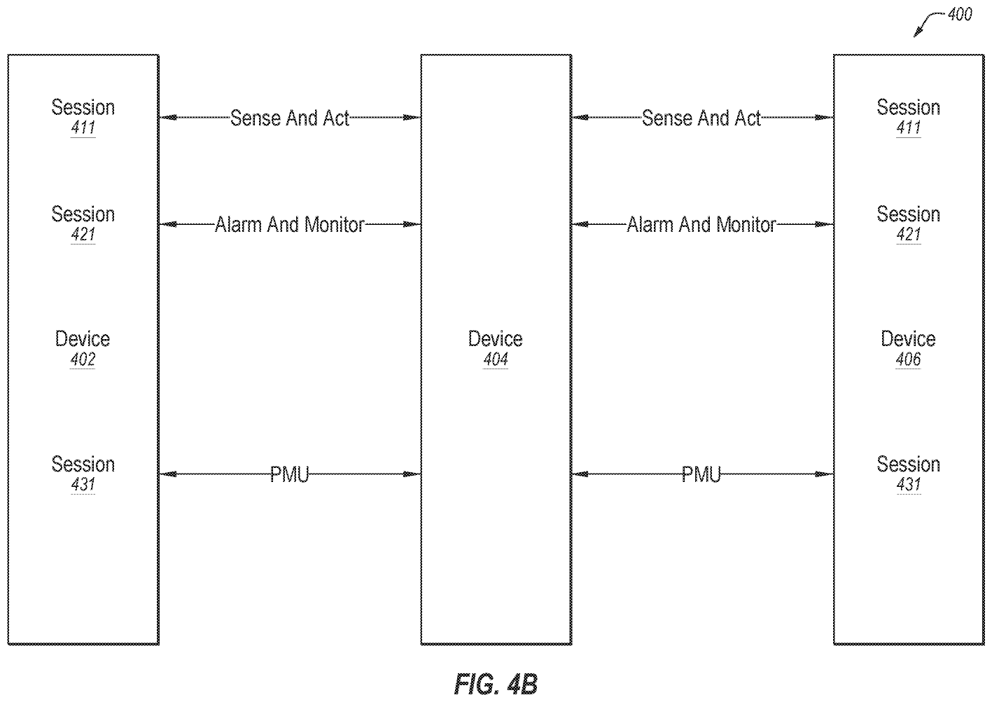

FIG. 4A and FIG. 4B illustrates an example system 400 including a device 402, a device 404, and a device 406, according to one or more embodiments of the present disclosure. System 400 may be an example of system 200 of FIG. 2. In particular, system 400 may be an example of system 200 which includes an Ethernet link between device 402 and device 406. Device 404 may be communicatively connected between device 402 and device 406 and may be configured to selectively constrain communication between device 402 and device 406.

Device 402, device 404, and device 406 may be connected in series via one or more Ethernet links. For example, each of device 402, device 404, and device 406 may include one or more Ethernet ports and Ethernet cables may connect device 402 to device 404 and device 404 to device 406.

Communication regarding different functions of one or more of device 402 and device 406 may be assigned to different Ethernet sessions. For example, as illustrated, communication regarding a “sense and act” functionality may be assigned to a session 411, communication regarding an “alarm and monitor” functionality may be assigned to a session 421, communication regarding a “PMU” functionality may be assigned to a session 431, and communication regarding “management” may be assigned to an Ethernet session 441.

Device 404 may be configured to constrain communication between device 402 and device 406 by, e.g., terminating one or more Ethernet sessions between device 402 and device 406. Further, device 404 may be configured to constrain communication by not allowing a terminated Ethernet session to reestablish. For example, in a permissive operational state (e.g., as illustrated in FIG. 4A), device 404 may be configured to allow communication in all sessions between device 402 and device 406. And, in a constrained operational state (e.g., as illustrated in FIG. 4B), device 404 may be configured to send a hold signal which may be effective to terminate an Ethernet session (e.g., Ethernet session 441). Further, device 404 may prevent a session (e.g., Ethernet session 441) from being reestablished while device 404 is in the constrained operational state.

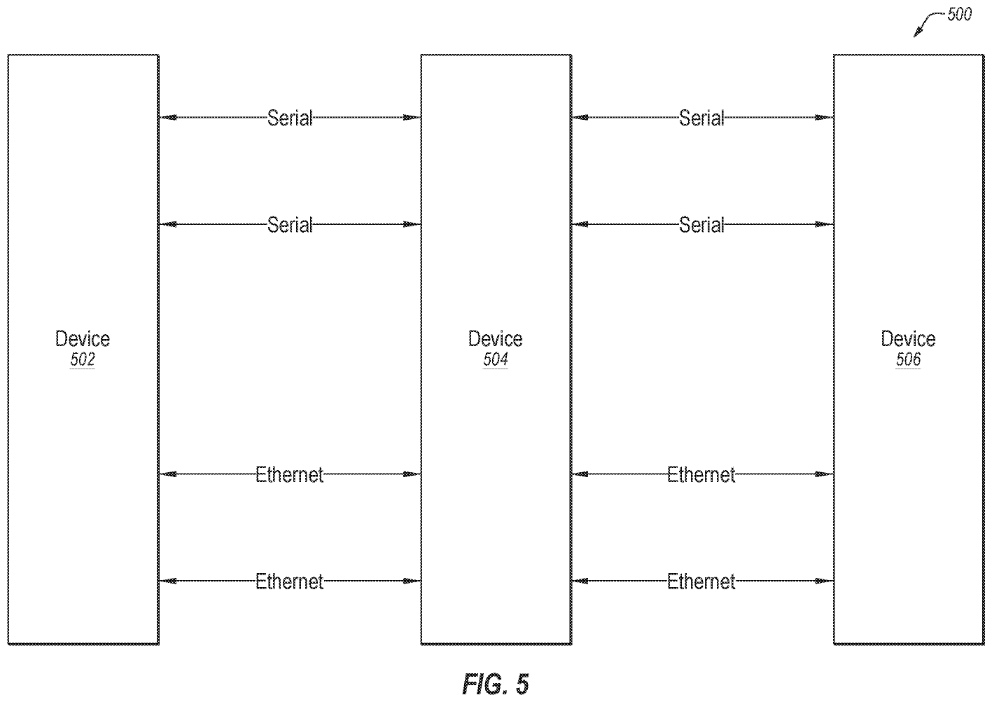

FIG. 5 illustrates an example system 500 including a device 502, a device 504, and a device 506, according to one or more embodiments of the present disclosure. System 500 may be an example of system 200 of FIG. 2. In particular, system 500 may be an example of system 200 which includes one or more serial data links between device 502 and device 506 and one or more Ethernet links between device 502 and device 506.

Device 504 may be communicatively connected between device 502 and device 506 and may be configured to selectively constrain communication between device 502 and device 506. For example, as described above with regard to FIGS. 3A and 3B, device 504 may be configured to selectively constrain communication on one or more serial data links. Additionally, as described above with regard to FIGS. 4A and 4B, device 504 may be configured to selectively constrain communication on one or more Ethernet communication links.

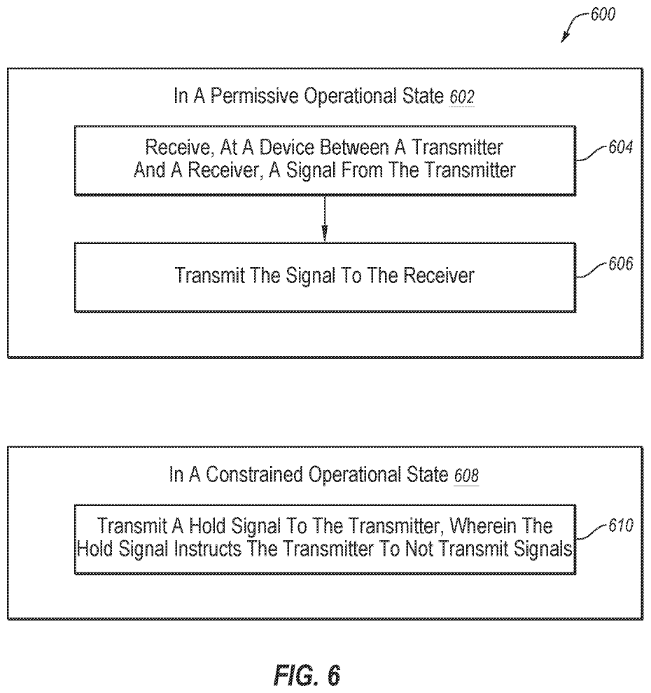

FIG. 6 is a flowchart of an example method 600, in accordance with various embodiments of the disclosure. At least a portion of method 600 may be performed, in some embodiments, by a device or system, such as PRPC 114 of FIG. 1, device 204 of FIG. 2, device 304 of FIG. 3A and FIG. 3B, device 504 of FIG. 5, or another device or system. Although illustrated as discrete blocks, various blocks may be divided into additional blocks, combined into fewer blocks, or eliminated, depending on the desired implementation.

At block 602, a system or device may be in a permissive operational state. For example, device 204 of FIG. 2 may be in the permissive operational state at block 602.

At block 604 (which may occur while the system or device is in the permissive operational state), a signal from a transmitter may be received at a device between the transmitter and a receiver. For example, device 204 may receive a signal from device 202 of FIG. 2 that was intended for device 206 of FIG. 2.

At block 606 (which may occur while the system or device is in the permissive operational state), the signal may be transmitted to the receiver. For example, the signal received at block 604 may be transmitted from device 204 to device 206 (see FIG. 2).

At block 608, the system or device may be in a constrained operational state. For example, device 204 of FIG. 2 may be in the constrained operational state at block 608.

At block 610 (which may occur while the system or device is in the constrained operational state), a hold signal may be transmitted to the transmitter. The hold signal may be interpretable by the transmitter as an instruction to not transmit signals (e.g., further signals). For example, with reference to FIG. 2, device 204 may transmit a hold signal to device 202 which may instruct device 202 to not transmit additional signals to device 206.

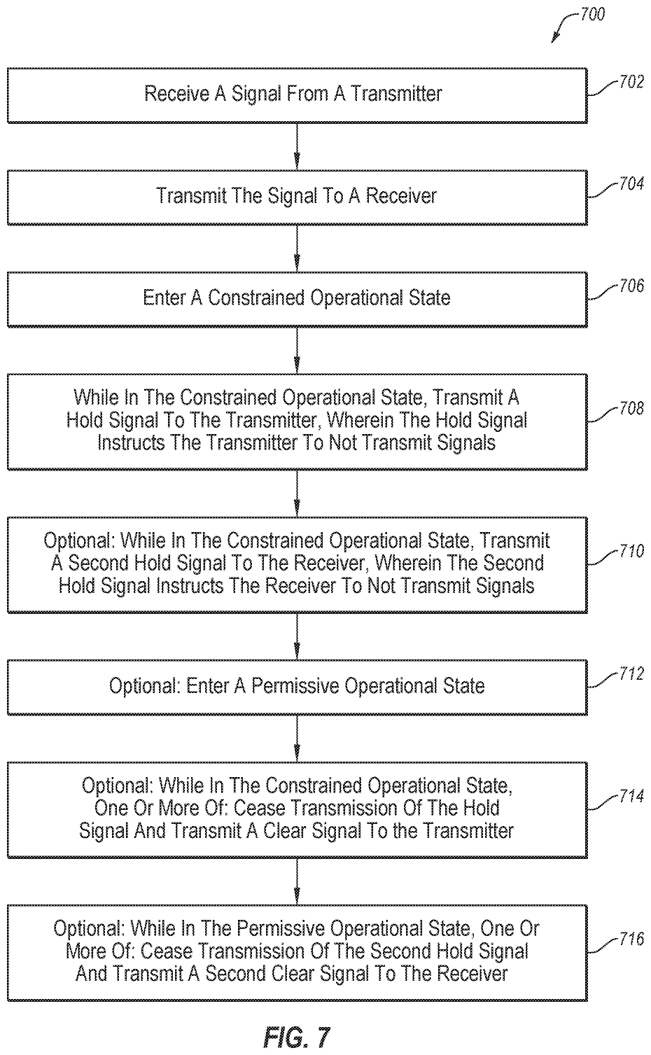

FIG. 7 is a flowchart of another example method 700, in accordance with various embodiments of the disclosure. At least a portion of method 700 may be performed, in some embodiments, by a device or system, such as PRPC 114 of FIG. 1, device 204 of FIG. 2, device 304 of FIG. 3A and FIG. 3B, device 504 of FIG. 5, or another device or system. Although illustrated as discrete blocks, various blocks may be divided into additional blocks, combined into fewer blocks, or eliminated, depending on the desired implementation.

At block 702, a signal may be received from a transmitter. For example, device 304 of FIG. 3 may receive a signal from device 302 of FIG. 3A and FIG. 3B.

At block 704, the signal may be transmitted to a receiver. Block 704 may occur while the recipient of the signal of block 702 and the transmitter of the signal at block 704 is in a permissive operational state. For example, device 304 may transmit the signal received at block 702 to device 306 of FIG. 3A and FIG. 3B. Further, device 304 may be in a permissive operational state when the signal is transmitted.

At block 706, a constrained operational state may be entered. For example, the recipient of the signal of block 702, and the transmitter of the signal at block 704 may enter a constrained operational state.

At block 708 (which may occur while the recipient of the signal of block 702 and the transmitter of the signal at block 704 is in a constrained operational state), a hold signal may be transmitted to the transmitter. The hold signal may be interpretable by the transmitter as an instruction to not transmit signals (e.g., further signals). For example, device 304 may transmit a hold signal to device 302 which may instruct device 302 to not transmit additional signals to device 306.

At block 710 (which is optional) (which may occur while the recipient of the signal of block 702 and the transmitter of the signal at block 704 is in a constrained operational state), a second hold signal may be transmitted to the receiver. The second hold signal may be interpretable by the receiver as an instruction to not transmit signals. For example, device 304 may transmit a hold signal to device 306 which may instruct device 306 to not transmit signals to device 302.

At block 712, (which is optional) a permissive operational state may be entered. For example, the recipient of the signal of block 702, and the transmitter of the signal at block 704 may enter a permissive operational state. For example, device 304 may enter a permissive operational state.

At block 714 (which is optional) (which may occur while the recipient of the signal of block 702 and the transmitter of the signal at block 704 is in a permissive operational state), transmission of the hold signal may cease and/or a clear signal may be transmitted to the transmitter. For example, device 304 may cease transmission of the hold signal of block 708 to device 302 and/or device 304 may transmit a clear signal to device 302.

At block 716 (which is optional) (which may occur while the recipient of the signal of block 702 and the transmitter of the signal at block 704 is in a permissive operational state), transmission of the second hold signal may cease and/or a second clear signal may be transmitted to the receiver. For example, device 304 may cease transmission of the second hold signal of block 710 to device 306 and/or device 304 may transmit a clear signal to device 306.

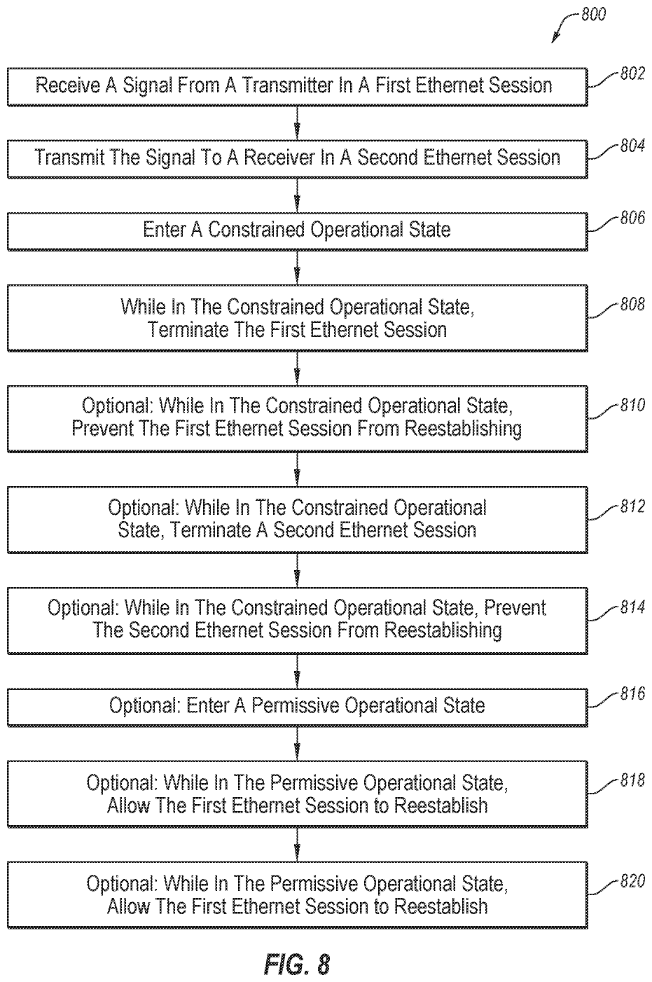

FIG. 8 is a flowchart of yet another example method 800, in accordance with various embodiments of the disclosure. At least a portion of method 800 may be performed, in some embodiments, by a device or system, such as PRPC 114 of FIG. 1, device 204 of FIG. 2, device 404 of FIG. 4A and FIG. 4B, device 504 of FIG. 5, or another device or system. Although illustrated as discrete blocks, various blocks may be divided into additional blocks, combined into fewer blocks, or eliminated, depending on the desired implementation.

At block 802, a signal may be received from a transmitter in a first Ethernet session. For example, device 404 of FIG. 4A and/or FIG. 4B may receive a signal from device 402 of FIG. 4A and/or FIG. 4B in a first Ethernet session, e.g., Ethernet session 441 of FIG. 4A and/or FIG. 4B.

At block 804, the signal may be transmitted to a receiver in a second Ethernet session. Block 804 may occur while the recipient of the signal of block 802 and the transmitter of the signal at block 804 is in a permissive operational state. For example, device 404 may transmit the signal received at block 802 to device 406 of FIG. 4A and/or FIG. 4B in a second Ethernet session, e.g., Ethernet session 441 of FIG. 4A and/or FIG. 4B. Further, device 404 may be in a permissive operational state when the signal is transmitted.

At block 806, a constrained operational state may be entered. For example, the recipient of the signal of block 802, and the transmitter of the signal at block 804 may enter a constrained operational state. For example, device 404 may enter a constrained operation state.

At block 808 (which may occur while the recipient of the signal of block 802 and the transmitter of the signal at block 804 is in a constrained operational state), the first Ethernet session may be terminated. For example, device 404 may terminate the first Ethernet session 441 with device 402.

At block 810 (which is optional) (which may occur while the recipient of the signal of block 802 and the transmitter of the signal at block 804 is in a constrained operational state), the first Ethernet session may be prevented from being reestablished. For example, device 404 may prevent an Ethernet session from being established between device 404 and device 402. In some embodiments, the Ethernet session prevented from being established may be a particular Ethernet session, e.g., a management Ethernet session, e.g., Ethernet session 441.

At block 812 (which is optional) (which may occur while the recipient of the signal of block 802 and the transmitter of the signal at block 804 is in a constrained operational state), the second Ethernet session may be terminated. For example, device 404 may terminate the second Ethernet session 441 with device 406.

At block 814 (which is optional) (which may occur while the recipient of the signal of block 802 and the transmitter of the signal at block 804 is in a constrained operational state), the second Ethernet session may be prevented from being reestablished. For example, device 404 may prevent an Ethernet session from being established between device 404 and device 406. In some embodiments, the Ethernet session prevented from being established may be a particular Ethernet session, e.g., a management Ethernet session, e.g., Ethernet session 441.

At block 816, (which is optional) a permissive operational state may be entered. For example, the recipient of the signal of block 802, and the transmitter of the signal at block 804 may enter a permissive operational state. For example, device 404 may enter a permissive operational state.

At block 818 (which is optional) (which may occur while the recipient of the signal of block 802 and the transmitter of the signal at block 804 is in a permissive operational state), the first Ethernet session may be allowed to be reestablished. For example, device 404 may allow the first Ethernet session 441 of block 802 between device 404 and device 402 to be reestablished.

At block 820 (which is optional) (which may occur while the recipient of the signal of block 802 and the transmitter of the signal at block 804 is in a permissive operational state), the second Ethernet session may be allowed to be reestablished. For example, device 404 may allow the first Ethernet session 441 of block 804 between device 404 and device 406 to be reestablished.

Modifications, additions, or omissions may be made to any of method 600 of FIG. 6, method 700 of FIG. 7, and/or method 800 of FIG. 8 without departing from the scope of the present disclosure. For example, the operations of method 600, method 700, and/or method 800 may be implemented in differing order. Furthermore, the outlined operations and actions are only provided as examples, and some of the operations and actions may be optional, combined into fewer operations and actions, or expanded into additional operations and actions without detracting from the essence of the disclosed example.

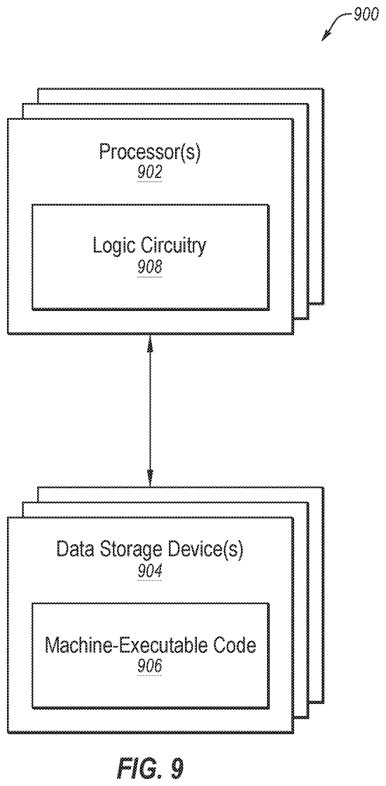

FIG. 9 is a block diagram of an example device 900 that, in various embodiments, may be used to implement various functions, operations, acts, processes, and/or methods disclosed herein. Device 900 includes one or more processors 902 (sometimes referred to herein as “processors 902”) operably coupled to one or more apparatuses such as data storage devices (sometimes referred to herein as “storage 904”), without limitation. Storage 904 includes machine-executable code 906 stored thereon (e.g., stored on a computer-readable memory) and processors 902 include logic circuitry 908. Machine-executable code 906 include information describing functional elements that may be implemented by (e.g., performed by) logic circuitry 908. Logic circuitry 908 is adapted to implement (e.g., perform) the functional elements described by machine-executable code 906. Device 900, when executing the functional elements described by machine-executable code 906, should be considered as special purpose hardware configured for carrying out the functional elements disclosed herein. In various embodiments, processors 902 may be configured to perform the functional elements described by machine-executable code 906 sequentially, concurrently (e.g., on one or more different hardware platforms), or in one or more parallel process streams.

When implemented by logic circuitry 908 of processors 902, machine-executable code 906 is configured to adapt processors 902 to perform operations of embodiments disclosed herein. For example, machine-executable code 906 may be configured to adapt processors 902 to perform at least a portion or a totality of method 600 of FIG. 6, method 700 of FIG. 7, and/or method 800 of FIG. 8. As another example, machine-executable code 906 may be configured to adapt processors 902 to perform at least a portion or a totality of the operations discussed for environment 100 of FIG. 1, system 200 of FIG. 2, system 300 of FIG. 3A and FIG. 3B, system 400 of FIG. 4A and FIG. 4B, system 500 of FIG. 5, and more specifically, one or more of PRPC 114 of FIG. 1, device 204 of FIG. 2, device 304 of FIG. 3A and FIG. 3B, device 404 of FIG. 4A and FIG. 4B, and/or device 504 of FIG. 5.

Processors 902 may include logic, including, e.g., a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is configured to execute computing instructions (e.g., software code) related to embodiments of the present disclosure. It is noted that a general-purpose processor (may also be referred to herein as a host processor or simply a host) may be a microprocessor, but in the alternative, processors 902 may include any conventional processor, controller, microcontroller, or state machine. Processors 902 may also be implemented as a combination of computing devices, such as a combination of a DSP and a microprocessor, a plurality of microprocessors, one or more microprocessors in conjunction with a DSP core, or any other such configuration.

In some embodiments, storage 904 includes volatile data storage (e.g., random-access memory (RAM)), non-volatile data storage (e.g., Flash memory, a hard disc drive, a solid state drive, erasable programmable read-only memory (EPROM), without limitation). In some embodiments processors 902 and storage 904 may be implemented into a single device (e.g., a semiconductor device product, a system on chip (SOC), without limitation). In some embodiments processors 902 and storage 904 may be implemented into separate devices.

In some embodiments, machine-executable code 906 may include computer-readable instructions (e.g., software code, firmware code). By way of non-limiting example, the computer-readable instructions may be stored by storage 904, accessed directly by processors 902, and executed by processors 902 using at least logic circuitry 908. Also by way of non-limiting example, the computer-readable instructions may be stored on storage 904, transmitted to a memory device (not shown) for execution, and executed by processors 902 using at least logic circuitry 908. Accordingly, in some embodiments logic circuitry 908 includes electrically configurable logic circuitry.

In some embodiments, machine-executable code 906 may describe hardware (e.g., circuitry) to be implemented in logic circuitry 908 to perform the functional elements. This hardware may be described at any of a variety of levels of abstraction, from low-level transistor layouts to high-level description languages. At a high-level of abstraction, a hardware description language (HDL) such as an Institute of Electrical and Electronics Engineers (IEEE) Standard hardware description language (HDL) may be used, without limitation. By way of non-limiting examples, VERILOG™, SYSTEM VERILOG™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of logic circuitry 908 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some embodiments, machine-executable code 906 may include an HDL, an RTL, a GL description, a mask level description, other hardware description, or any combination thereof.

In some embodiments, where machine-executable code 906 includes a hardware description (at any level of abstraction), a system (not shown, but including storage 904) may be configured to implement the hardware description described by machine-executable code 906. By way of non-limiting example, processors 902 may include a programmable logic device (e.g., an FPGA or a PLC) and the logic circuitry 908 may be electrically controlled to implement circuitry corresponding to the hardware description into logic circuitry 908. Also by way of non-limiting example, logic circuitry 908 may include hard-wired logic manufactured by a manufacturing system (not shown, but including storage 904) according to the hardware description of machine-executable code 906.

Regardless of whether machine-executable code 906 includes computer-readable instructions or a hardware description, logic circuitry 908 is adapted to perform the functional elements described by machine-executable code 906 when implementing the functional elements of machine-executable code 906. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, without limitation) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different sub-combinations of some of the elements. For example, the phrase “A, B, C, D, or combinations thereof” may refer to any one of A, B, C, or D; the combination of each of A, B, C, and D; and any sub-combination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to some embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the invention as hereinafter claimed, including legal equivalents thereof. In addition, features from one embodiment may be combined with features of another embodiment while still being encompassed within the scope of the invention. Further, embodiments of the disclosure have utility with different and various detector types and configurations.

1. A method, comprising:
in a permissive operational state of a device between a transmitter and a receiver:
receiving, at the device, a signal from the transmitter; and
transmitting, from the device, the signal to the receiver; and
in a constrained operational state of the device:
transmitting, from the device, a hold signal to the transmitter at least partially responsive to the device being in the constrained operational state, wherein the hold signal instructs the transmitter to not transmit signals.

2. The method of claim 1, wherein the signal is received in a first Ethernet session at a first Ethernet port, wherein the signal is sent in a second Ethernet session at a second Ethernet port, and wherein transmitting the hold signal comprises terminating the first Ethernet session.

3. The method of claim 2, further comprising, after terminating the first Ethernet session, preventing the first Ethernet session from reestablishing while in the constrained operational state.

4. A method, comprising:
receiving, at a device between a transmitter and a receiver, a signal from the transmitter;
transmitting, from the device, the signal to the receiver;
entering a constrained operational state of the device; and
transmitting, from the device, at least partially responsive to entering the constrained operational state, a hold signal to the transmitter, wherein the hold signal instructs the transmitter to not transmit signals.

5. The method of claim 4, further comprising:
entering a permissive operational state; and
while in the permissive operational state, one or more of: ceasing transmission of the hold signal and transmitting a clear signal to the transmitter.

6. The method of claim 4, further comprising, while in the constrained operational state, transmitting a second hold signal to the receiver, wherein the second hold signal instructs the receiver to not transmit signals.

7. The method of claim 6, further comprising:
entering a permissive operational state;
while in the permissive operational state, one or more of: ceasing transmission of the hold signal and transmitting a clear signal to the transmitter; and
while in the permissive operational state, one or more of: ceasing transmission of the second hold signal and transmitting a second clear signal to the receiver.

8. The method of claim 4, wherein the signal is received at a first serial port, wherein the signal is transmitted at a second serial port, and wherein transmitting the hold signal comprises transmitting the hold signal at the first serial port.

9. The method of claim 8, wherein transmitting the hold signal comprises changing a voltage on a clear-to-send line of the first serial port.

10. The method of claim 8, further comprising, while in the constrained operational state, transmitting a second hold signal to the receiver, wherein the second hold signal instructs the receiver to not transmit signals, wherein transmitting the second hold signal comprises changing a voltage on a request-to-send line of the second serial port.

11. The method of claim 4, wherein the signal is received in a first Ethernet session at a first Ethernet port, wherein the signal is sent in a second Ethernet session at a second Ethernet port, and wherein transmitting the hold signal comprises terminating the first Ethernet session.

12. The method of claim 11, further comprising, after terminating the first Ethernet session, preventing the first Ethernet session from reestablishing while in the constrained operational state.

13. The method of claim 11, further comprising, while in the constrained operational state, terminating the second Ethernet session.

14. The method of claim 13, further comprising, after terminating the second Ethernet session, preventing the second Ethernet session from reestablishing while in the constrained operational state.

15. A device, comprising:
a first port configured to be communicatively coupled to a first device;
a second port configured to be communicatively coupled to a second device; and
logic configured to:
in a permissive operational state:
receive a signal from the first device; and
transmit the signal to the second device; and
in a constrained operational state, transmit a hold signal to the first device at least partially responsive to the constrained operational state, wherein the hold signal instructs the first device to not transmit signals.

16. The device of claim 15, wherein the first port comprises a first serial-communication port and the second port comprises a second serial-communication port.

17. The device of claim 16, wherein the hold signal comprises a voltage on a line of the first serial-communication port.

18. The device of claim 17, wherein the line is a clear-to-send line.

19. The device of claim 16, wherein the logic is configured to, in the constrained operational state, transmit a second hold signal to the second device, wherein the second hold signal instructs the second device to not transmit signals, wherein the second hold signal changes a voltage on a second line of the second serial-communication port.

20. The device of claim 19, where the second line is a request-to-send line.

21. The device of claim 15, wherein the first port comprises a first Ethernet port, wherein the logic is configured to receive the signal in a first Ethernet session at the first Ethernet port, wherein the second port comprises a second Ethernet port, wherein the logic is configured to transmit the signal in a second Ethernet session at the second Ethernet port.

22. The device of claim 21, wherein the hold signal comprises an instruction to terminate the first Ethernet session.

23. The device of claim 22, wherein the logic is further configured to, in the constrained operational state, prevent the first Ethernet session from being reestablished.

24. The device of claim 21, wherein the logic is further configured, while in the constrained operational state, to transmit a second hold signal to the second device, wherein the second hold signal instructs the second device to not transmit signals, wherein the second hold signal comprises an instruction to terminate the second Ethernet session.
